(19) United States
(12) Patent Application Publication
(10) Pub. No.: US 2015/0264483 A1
(43) Pub. Date: Sep. 17, 2015

(54) LOW FREQUENCY RENDERING OF HIGHER-ORDER AMBISONIC AUDIO DATA

(71) Applicant: QUALCOMM Incorporated, San Diego, CA (US)

(72) Inventors: Martin James Morrell, San Diego, CA (US); Nils Günther Peters, San Diego, CA (US); Dipanjan Sen, San Diego, CA (US)

(21) Appl. No.: 14/656,210

(22) Filed: Mar. 12, 2015

Related U.S. Application Data
(60) Provisional application No. 61/953,229, filed on Mar. 14, 2014.
(60) Provisional application No. 62/004,133, filed on May 28, 2014.

(51) Int. Cl. H04R 5/02; G10L 19/08

(52) U.S. Cl. CPC H04R 5/02; G10L 19/08

(57) ABSTRACT

In general, techniques are described for low frequency rendering of higher-order ambisonic audio data. As an example, a device comprising a memory and a processor may perform the techniques. The memory may be configured to store higher-order ambisonic coefficients. The processor may be configured to obtain a renderer to be used when rendering the higher-order ambisonic coefficients into a speaker feed for a low frequency speaker.

This application claims the benefit of the following:
U.S. Provisional Application No. 61/953,229, filed Mar. 14, 2014, entitled “LOW FREQUENCY RENDERING OF HIGHER ORDER AMBISONIC COEFFICIENTS;” and
U.S. Provisional Application No. 62/004,133, filed May 28, 2014, entitled “LOW FREQUENCY RENDERING OF HIGHER ORDER AMBISONIC COEFFICIENTS,”
   each of which are hereby incorporated by reference as if set forth in their entirety herein.

### TECHNICAL FIELD

This disclosure relates to audio rendering and, more specifically, rendering of higher-order ambisonic audio data.

### BACKGROUND

A higher-order ambisonics (HOA) signal (often represented by a plurality of spherical harmonic coefficients (SHC) or other hierarchical elements) is a three-dimensional representation of a soundfield. The HOA or SHC representation may represent the soundfield in a manner that is independent of the local speaker geometry used to playback a multi-channel audio signal rendered from the SHC signal. The SHC signal may also facilitate backwards compatibility as the SHC signal may be rendered to well-known and highly adopted multi-channel formats, such as a 5.1 audio channel format or a 7.1 audio channel format. The SHC representation may therefore enable a better representation of a soundfield that also accommodates backward compatibility.

### SUMMARY

In general, techniques are described for rendering low frequency speaker feeds from higher-order ambisonic coefficients.

In one aspect, a device configured to renderer higher-order ambisonic coefficients may perform the techniques. The device may comprise a memory configured to store the higher-order ambisonic coefficients, and one or more processors configured to obtain a renderer to be used when rendering the higher-order ambisonic coefficients into a speaker feed for a low frequency speaker.

In another aspect, a method of rendering higher-order ambisonic coefficients comprises obtaining a renderer to be used when rendering the higher-order ambisonic coefficients into a speaker feed for a low frequency speaker.

In another aspect, a device configured to renderer higher-order ambisonic coefficients may perform the techniques. The device may comprise means for storing the higher-order ambisonic coefficients, and means for obtaining a renderer to be used when rendering the higher-order ambisonic coefficients into a speaker feed for a low frequency speaker.

In another aspect, a non-transitory computer-readable storage medium has stored thereon instructions that, when executed, cause one or more processors to store higher-order ambisonic coefficients, and obtain a renderer to be used when rendering the higher-order ambisonic coefficients into a speaker feed for a low frequency speaker.

The details of one or more aspects of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a diagram illustrating spherical harmonic basis functions of various orders and sub-orders.

FIG. 2 is a diagram illustrating a system configured to perform various aspects of the low frequency rendering techniques described in this disclosure.

FIG. 3 is a block diagram illustrating the renderer determination unit of FIG. 2 in more detail.

FIG. 4 is a flowchart illustrating exemplary operation of an audio playback system in performing the low frequency rendering techniques described in this disclosure.

### DETAILED DESCRIPTION

The evolution of surround sound has made available many output formats for entertainment nowadays. Examples of such consumer surround sound formats are mostly ‘channel’ based in that they implicitly specify feeds to loudspeakers in certain geometrical coordinates. The consumer surround sound formats include the popular 5.1 format (which includes the following six channels: front left (FL), front right (FR), center or front center, back left or surround left, back right or surround right, and low frequency effects (LFE)), the growing 7.1 format, various formats that includes height speakers such as the 7.1.4 format and the 22.2 format (e.g., for use with the Ultra High Definition Television standard). Non-consumer formats can span any number of speakers (in symmetric and non-symmetric geometries) often termed ‘surround arrays’. One example of such an array includes 32 loudspeakers positioned on coordinates on the corners of a truncated icosahedron.

The input to a future MPEG encoder is optionally one of three possible formats: (i) traditional channel-based audio (as discussed above), which is meant to be played through loudspeakers at pre-specified positions; (ii) object-based audio, which involves discrete pulse-code-modulation (PCM) data for single audio objects with associated metadata containing their location coordinates (amongst other information); and (iii) scene-based audio, which involves representing the soundfield using coefficients of spherical harmonic basis functions (also called “spherical harmonic coefficients” or SHC, “Higher-order Ambisonics” or HOA, and “HOA coefficients”). The future MPEG encoder may be described in more detail in a document entitled “Call for Proposals for 3D Audio,” by the International Organization for Standardization/International Electrotechnical Commission (ISO)/(IEC) JTC1/SC29/WG11/N13411, released January 2013 in Geneva, Switzerland, and available at http://mpeg.chiariglione.org/sites/default/files/files/standards/parts/docs/w13411.zip.

There are various ‘surround-sound’ channel-based formats in the market. They range, for example, from the 5.1 home theatre system (which has been the most successful in terms of making inroads into living rooms beyond stereo) to the 22.2 system developed by NHK (Nippon Hoso Kyokai or Japan Broadcasting Corporation). Content creators (e.g., Hollywood studios) would like to produce the soundtrack for a movie once, and not spend effort to remix it for each speaker configuration. Recently, Standards Developing Organizations have been considering ways in which to provide an encoding into a standardized bitstream and a subsequent decoding that is adaptable and agnostic to the speaker geometry (and number) and acoustic conditions at the location of the playback (involving a renderer).

To provide such flexibility for content creators, a hierarchical set of elements may be used to represent a soundfield. The hierarchical set of elements may refer to a set of elements in which the elements are ordered such that a basic set of lower-ordered elements provides a full representation of the modeled soundfield. As the set is extended to include higher-order elements, the representation becomes more detailed, increasing resolution.

One example of a hierarchical set of elements is a set of spherical harmonic coefficients (SHC). The following expression demonstrates a description or representation of a soundfield using SHC:

$${p}_{i} ( t , {r}_{r} , {θ}_{r} , {ϕ}_{r} ) = {\sum }_{ω = 0}^{∞} [ 4 π {\sum }_{n = 0}^{∞} {j}_{n} ( {kr}_{r} ) {\sum }_{m = - n}^{n} {A}_{n}^{m} ( k ) {Y}_{n}^{m} ( {θ}_{r} , {ϕ}_{r} ) ] {e}^{jω t} ,$$

The expression shows that the pressure pᵢ at any point {rᵣ, θᵣ, φᵣ} of the soundfield, at time t, can be represented uniquely by the SHC, Aₙ^{m}(k). Here,

$$k = \frac{ω}{c} ,$$

c is the speed of sound (˜343 m/s), {rᵣ, θᵣ, φᵣ} is a point of reference (or observation point), jₙ(·) is the spherical Bessel function of order n, and Yₙ^{m}(θᵣ, φᵣ) are the spherical harmonic basis functions of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

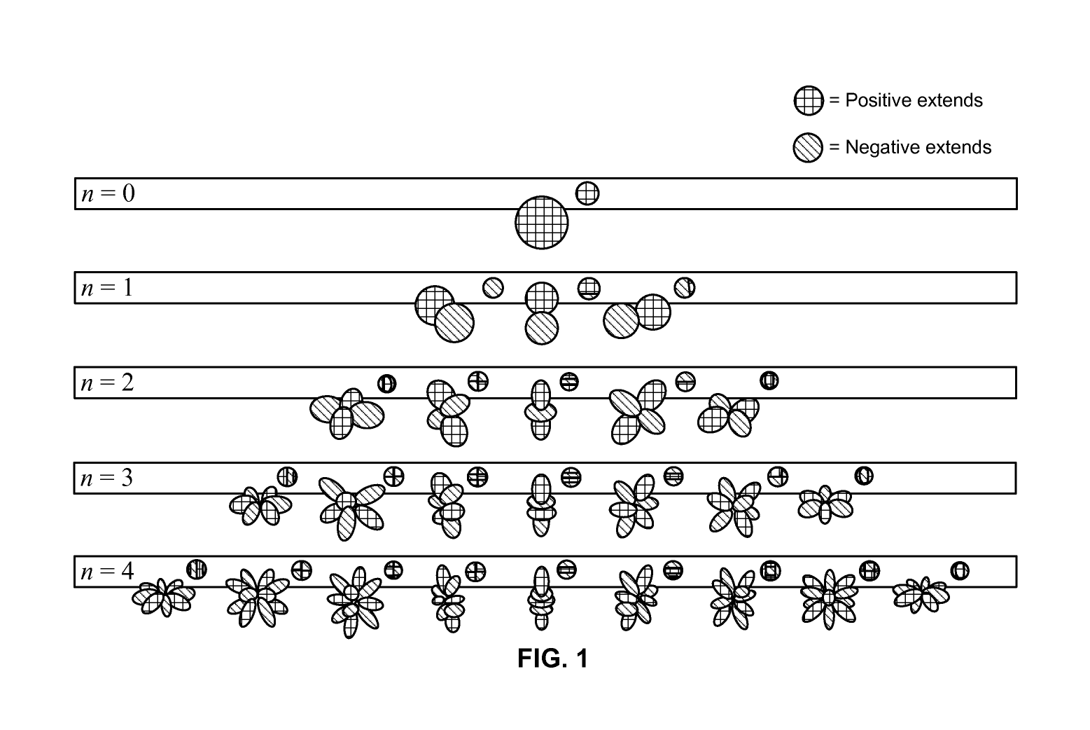

FIG. 1 is a diagram illustrating spherical harmonic basis functions from the zero-order (n=0) to the fourth-order (n=4). As can be seen, for each order, there is an expansion of suborders m which are shown but not explicitly noted in the example of FIG. 1 for ease of illustration purposes.

The SHC Aₙ^{m}(k) can either be physically acquired (e.g., recorded) by various microphone array configurations or, alternatively, they can be derived from channel-based or object-based descriptions of the soundfield. The SHC represent scene-based audio, where the SHC may be input to an audio encoder to obtain encoded SHC that may promote more efficient transmission or storage. For example, a fourth-order representation involving (1+4)² (25, and hence fourth-order) coefficients may be used.

As noted above, the SHC may be derived from a microphone recording using a microphone array. Various examples of how SHC may be derived from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

To illustrate how the SHCs may be derived from an object-based description, consider the following equation. The coefficients Aₙ^{m}(k) for the soundfield corresponding to an individual audio object may be expressed as:

Aₙ^{m}(k)=g(ω)(−4πik)hₙ⁽²⁾(krₛ)Yₙ^{m*}(θₛ,φₛ),

where i is \sqrt{−1}, hₙ⁽²⁾(·) is the spherical Hankel function (of the second kind) of order n, and {rₛ, θₛ, φₛ} is the location of the object. Knowing the object source energy g(ω) as a function of frequency (e.g., using time-frequency analysis techniques, such as performing a fast Fourier transform on the PCM stream) allows us to convert each PCM object and the corresponding location into the SHC Aₙ^{m}(k). Further, it can be shown (since the above is a linear and orthogonal decomposition) that the Aₙ^{m}(k) coefficients for each object are additive. In this manner, a multitude of PCM objects can be represented by the Aₙ^{m}(k) coefficients (e.g., as a sum of the coefficient vectors for the individual objects). Essentially, the coefficients contain information about the soundfield (the pressure as a function of 3D coordinates), and the above represents the transformation from individual objects to a representation of the overall soundfield, in the vicinity of the observation point {rᵣ, θᵣ, φᵣ}. The remaining figures are described below in the context of object-based and SHC-based audio coding.

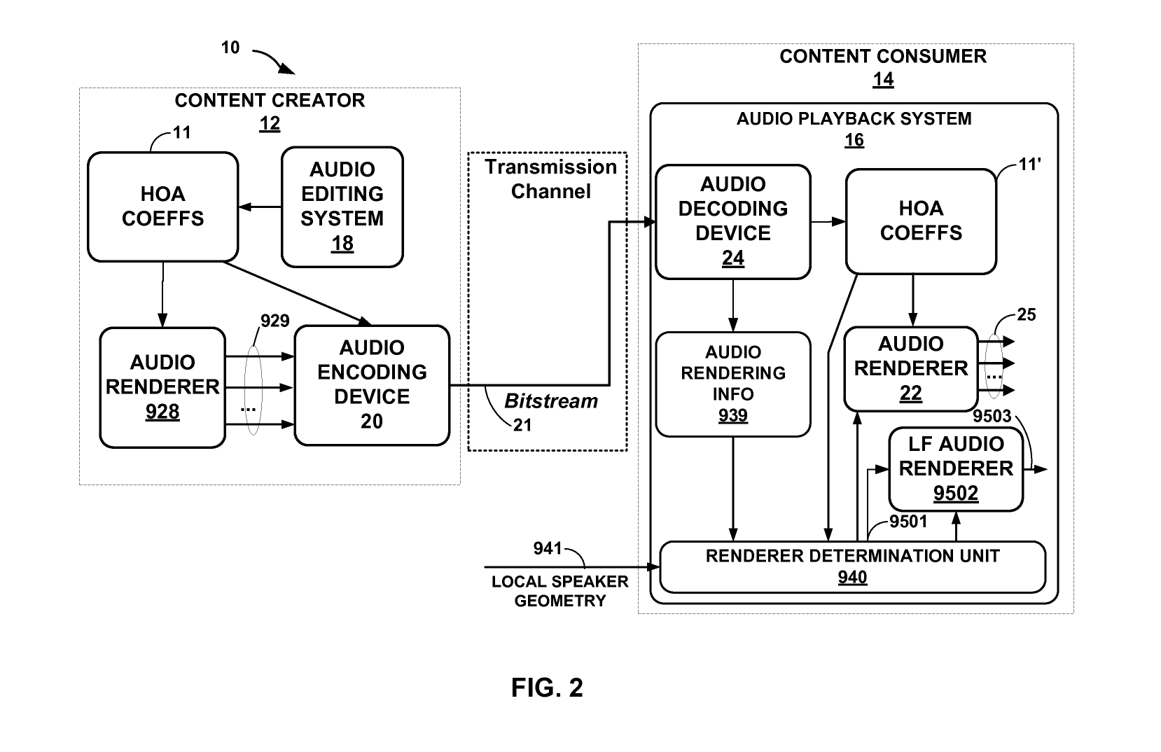

FIG. 2 is a diagram illustrating a system 10 that may perform various aspects of the techniques described in this disclosure. As shown in the example of FIG. 2, the system 10 includes a content creator device 12 and a content consumer device 14. While described in the context of the content creator device 12 and the content consumer device 14, the techniques may be implemented in any context in which SHCs (which may also be referred to as HOA coefficients) or any other hierarchical representation of a soundfield are encoded to form a bitstream representative of the audio data. Moreover, the content creator device 12 may represent any form of computing device capable of implementing the techniques described in this disclosure, including a handset (or cellular phone), a tablet computer, a smart phone, or a desktop computer to provide a few examples. Likewise, the content consumer device 14 may represent any form of computing device capable of implementing the techniques described in this disclosure, including a handset (or cellular phone), a tablet computer, a smart phone, a set-top box, or a desktop computer to provide a few examples.

The content creator device 12 may be operated by a movie studio or other entity that may generate multi-channel audio content for consumption by operators of content consumer devices, such as the content consumer device 14. In some examples, the content creator device 12 may be operated by an individual user who would like to compress HOA coefficients 11. Often, the content creator generates audio content in conjunction with video content. The content consumer device 14 may be operated by an individual. The content consumer device 14 may include an audio playback system 16, which may refer to any form of audio playback system capable of rendering SHC for play back as multi-channel audio content.

The content creator device 12 includes an audio editing system 18. The content creator device 12 obtain live recordings 7 in various formats (including directly as HOA coefficients) and audio objects 9, which the content creator device 12 may edit using audio editing system 18. The content creator may, during the editing process, render HOA coefficients 11 from audio objects 9, listening to the rendered speaker feeds in an attempt to identify various aspects of the soundfield that require further editing. The content creator device 12 may then edit HOA coefficients 11 (potentially indirectly through manipulation of different ones of the audio objects 9 from which the source HOA coefficients may be derived in the manner described above). The content creator device 12 may employ the audio editing system 18 to generate the HOA coefficients 11. The audio editing system 18 represents any system capable of editing audio data and outputting the audio data as one or more source spherical harmonic coefficients.

When the editing process is complete, the content creator device 12 may generate a bitstream 21 based on the HOA coefficients 11. That is, the content creator device 12 includes an audio encoding device 20 that represents a device configured to encode or otherwise compress HOA coefficients 11 in accordance with various aspects of the techniques described in this disclosure to generate the bitstream 21. The audio encoding device 20 may generate the bitstream 21 for transmission, as one example, across a transmission channel, which may be a wired or wireless channel, a data storage device, or the like. The bitstream 21 may represent an encoded version of the HOA coefficients 11 and may include a primary bitstream and another side bitstream, which may be referred to as side channel information.

While shown in FIG. 2 as being directly transmitted to the content consumer device 14, the content creator device 12 may output the bitstream 21 to an intermediate device positioned between the content creator device 12 and the content consumer device 14. The intermediate device may store the bitstream 21 for later delivery to the content consumer device 14, which may request the bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding video data bitstream) to subscribers, such as the content consumer device 14, requesting the bitstream 21.

Alternatively, the content creator device 12 may store the bitstream 21 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to the channels by which content stored to the mediums are transmitted (and may include retail stores and other store-based delivery mechanism). In any event, the techniques of this disclosure should not therefore be limited in this respect to the example of FIG. 2.

As further shown in the example of FIG. 2, the content consumer device 14 includes the audio playback system 16. The audio playback system 16 may represent any audio playback system capable of playing back multi-channel audio data. The audio playback system 16 may include a number of different renderers 22. The renderers 22 may each provide for a different form of rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 16 may further include an audio decoding device 24. The audio decoding device 24 may represent a device configured to decode HOA coefficients 11′ from the bitstream 21, where the HOA coefficients 11′ may be similar to the HOA coefficients 11 but differ due to lossy operations (e.g., quantization) and/or transmission via the transmission channel. The audio playback system 16 may, after decoding the bitstream 21 to obtain the HOA coefficients 11′ and render the HOA coefficients 11′ to output loudspeaker feeds 25. The loudspeaker feeds 25 may drive one or more loudspeakers (which are not shown in the example of FIG. 2 for ease of illustration purposes).

To select the appropriate renderer or, in some instances, generate an appropriate renderer, the audio playback system 16 may obtain loudspeaker information 13 indicative of a number of loudspeakers and/or a spatial geometry of the loudspeakers. In some instances, the audio playback system 16 may obtain the loudspeaker information 13 using a reference microphone and driving the loudspeakers in such a manner as to dynamically determine the loudspeaker information 13. In other instances or in conjunction with the dynamic determination of the loudspeaker information 13, the audio playback system 16 may prompt a user to interface with the audio playback system 16 and input the loudspeaker information 13.

The audio playback system 16 may then select one of the audio renderers 22 based on the loudspeaker information 13. In some instances, the audio playback system 16 may, when none of the audio renderers 22 are within some threshold similarity measure (in terms of the loudspeaker geometry) to the loudspeaker geometry specified in the loudspeaker information 13, generate the one of audio renderers 22 based on the loudspeaker information 13. The audio playback system 16 may, in some instances, generate one of the audio renderers 22 based on the loudspeaker information 13 without first attempting to select an existing one of the audio renderers 22.

The audio playback system 16 may also include a renderer determination unit 940 that may represent a unit configured to determine or otherwise select an audio renderer from among a plurality of audio renderers 22. In some instances, the renderer determination unit 940 may select the renderer from a number of pre-defined renderers. In other instances, the renderer determination unit 940 may dynamically determine the audio renderer based on local speaker geometry information included in loudspeaker information 13. The local speaker geometry information may specify a location of each speaker coupled to the audio playback system 16 relative to the audio playback system 16, a listener, or any other identifiable region or location. Often, a listener may interface with the audio playback system 16 via a graphical user interface (GUI) or other form of interface to input the local speaker geometry information. In some instances, the audio playback system 16 may automatically (meaning, in this example, without requiring any listener intervention) determine the local speaker geometry information often by emitting certain tones and measuring the tones via a microphone coupled to the audio playback system 16.

In any event, each of the above renderers 22 may provide for a different form of rendering, where the different forms of rendering may include one or more of the various ways of performing vector-base amplitude panning (VBAP), one or more of the various ways of performing distance based amplitude panning (DBAP), one or more of the various ways of performing simple panning, one or more of the various ways of performing near field compensation (NFC) filtering and/or one or more of the various ways of performing wave field synthesis. The selected renderer 22 may then render HOA coefficients 11′ to generate a number of loudspeaker feeds 25 (corresponding to the number of loudspeakers electrically or possibly wirelessly coupled to audio playback system 16, which are not shown in the example of FIG. 2 for ease of illustration purposes).

Typically, the audio playback system 16 may select any one of a plurality of audio renderers and may be configured to select one or more of audio renderers depending on the source from which the bitstream 21 is received (such as a DVD player, a Blu-ray player, a smartphone, a tablet computer, a gaming system, and a television to provide a few examples). While any one of the audio renderers may be selected, often the audio renderer used when creating the content provides for a better (and possibly the best) form of rendering due to the fact that the content was created by the content creator 12 using this one of audio renderers. Selecting the one of the audio renderers 22 having a rendering form that is the same as or at least close to the rendering form of the local speaker geometry may provide for a better representation of the sound field that may result in a better surround sound experience for the content consumer 14.

The audio encoding device 20 may generate the bitstream 21 to include the audio rendering information. The audio rendering information may include a signal value identifying an audio renderer used when generating the multi-channel audio content. In some instances, the signal value includes a matrix used to render spherical harmonic coefficients to a plurality of speaker feeds.

In some instances, the signal value includes two or more bits that define an index that indicates that the bitstream includes a matrix used to render spherical harmonic coefficients to a plurality of speaker feeds. In some instances, when an index is used, the signal value further includes two or more bits that define a number of rows of the matrix included in the bitstream and two or more bits that define a number of columns of the matrix included in the bitstream. Using this information and given that each coefficient of the two-dimensional matrix is typically defined by a 32-bit floating point number, the size in terms of bits of the matrix may be computed as a function of the number of rows, the number of columns, and the size of the floating point numbers defining each coefficient of the matrix, i.e., 32-bits in this example.

In some instances, the signal value specifies a rendering algorithm used to render spherical harmonic coefficients to a plurality of speaker feeds. The rendering algorithm may include a matrix that is known to both the audio encoding device 20 and the audio decoding device 24. That is, the rendering algorithm may include application of a matrix in addition to other rendering steps, such as panning (e.g., VBAP, DBAP or simple panning) or NFC filtering. In some instances, the signal value includes two or more bits that define an index associated with one of a plurality of matrices used to render spherical harmonic coefficients to a plurality of speaker feeds. Again, both the audio encoding device 20 and the audio decoding device 24 may be configured with information indicating the plurality of matrices and the order of the plurality of matrices such that the index may uniquely identify a particular one of the plurality of matrices. Alternatively, audio encoding device 20 may specify data in the bitstream 21 defining the plurality of matrices and/or the order of the plurality of matrices such that the index may uniquely identify a particular one of the plurality of matrices.

In some instances, the signal value includes two or more bits that define an index associated with one of a plurality of rendering algorithms used to render spherical harmonic coefficients to a plurality of speaker feeds. Again, both the audio encoding device 20 and the audio decoding device 24 may be configured with information indicating the plurality of rendering algorithms and the order of the plurality of rendering algorithms such that the index may uniquely identify a particular one of the plurality of matrices. Alternatively, the audio encoding device 20 may specify data in the bitstream 21 defining the plurality of matrices and/or the order of the plurality of matrices such that the index may uniquely identify a particular one of the plurality of matrices.

In some instances, the audio encoding device 20 specifies audio rendering information on a per audio frame basis in the bitstream 21. In other instances, the audio encoding device 20 specifies the audio rendering information a single time in the bitstream.

The audio decoding device 24 may then determine audio rendering information specified in the bitstream 21. Based on the signal value included in the audio rendering information, the audio playback system 16 may render a plurality of loudspeaker feeds 25 based on the audio rendering information specified in the bitstream 21. As noted above, the signal value may in some instances include a matrix used to render spherical harmonic coefficients to a plurality of speaker feeds. In this case, the audio playback system 16 may configure one of the audio renderers 22 with the matrix, using this one of the audio renderers 22 to render the loudspeaker feeds 25 based on the matrix.

In some instances, the signal value includes two or more bits that define an index that indicates that the bitstream 21 includes a matrix used to render the HOA coefficients 11′ to the loudspeaker feeds 25. The audio decoding device 24 may parse the matrix from the bitstream 21 in response to the index, whereupon the audio playback system 16 may configure one of the audio renderers 22 with the parsed matrix and invoke this one of the renderers 22 to render the loudspeaker feeds 25. When the signal value includes two or more bits that define a number of rows of the matrix included in the bitstream 21 and two or more bits that define a number of columns of the matrix included in the bitstream 21, the audio decoding device 24 may parse the matrix from the bitstream 21 in response to the index and based on the two or more bits that define a number of rows and the two or more bits that define the number of columns in the manner described above.

In some instances, the signal value specifies a rendering algorithm used to render the HOA coefficients 11′ to the loudspeaker feeds 25. In these instances, some or all of the audio renderers 22 may perform these rendering algorithms. The audio playback device 16 may then utilize the specified rendering algorithm, e.g., one of the audio renderers 22, to render the loudspeaker feeds 25 from the HOA coefficients 11′.

When the signal value includes two or more bits that define an index associated with one of a plurality of matrices used to render the HOA coefficients 11′ to the loudspeaker feeds 25, some or all of the audio renderers 22 may represent this plurality of matrices. Thus, the audio playback system 16 may render the loudspeaker feeds 25 from the HOA coefficients 11′ using the one of the audio renderers 22 associated with the index.

When the signal value includes two or more bits that define an index associated with one of a plurality of rendering algorithms used to render the HOA coefficients 11′ to the loudspeaker feeds 25, some or all of the audio renderers 22 may represent these rendering algorithms. Thus, the audio playback system 16 may render the loudspeaker feeds 25 from the HOA coefficients 11′ using one of the audio renderers 22 associated with the index.

Depending on the frequency with which this audio rendering information is specified in the bitstream 21, the audio decoding device 24 may determine the audio rendering information on a per audio frame basis or a single time.

By specifying the audio rendering information in this manner, the techniques may potentially result in better reproduction of the multi-channel audio content 25 and according to the manner in which the content creator 12 intended the multi-channel audio content 25 to be reproduced. As a result, the techniques may provide for a more immersive surround sound or multi-channel audio experience.

While described as being signaled (or otherwise specified) in the bitstream 21, the audio rendering information may be specified as metadata separate from the bitstream 21 or, in other words, as side information separate from the bitstream 21. The audio encoding device 20 may generate this audio rendering information separate from the bitstream 21 so as to maintain bitstream compatibility with (and thereby enable successful parsing by) those extraction devices that do not support the techniques described in this disclosure. Accordingly, while described as being specified in the bitstream 21, the techniques may allow for other ways by which to specify the audio rendering information separate from the bitstream 21.

Moreover, while described as being signaled or otherwise specified in the bitstream 21 or in metadata or side information separate from the bitstream 21, the techniques may enable the audio encoding device 20 to specify a portion of the audio rendering information in the bitstream 21 and a portion of the audio rendering information as metadata separate from the bitstream 21. For example, the audio encoding device 20 may specify the index identifying the matrix in the bitstream 21, where a table specifying a plurality of matrixes that includes the identified matrix may be specified as metadata separate from the bitstream 21. The audio playback system 16 may then determine the audio rendering information from the bitstream 21 in the form of the index and from the metadata specified separately from the bitstream 21. The audio playback system 16 may, in some instances, be configured to download or otherwise retrieve the table and any other metadata from a pre-configured or configured server (most likely hosted by the manufacturer of the audio playback system 16 or a standards body).

However, as is often the case, the content consumer 14 does not properly configure the speakers according to a specified (typically by the surround sound audio format body) geometry. Often, the content consumer 14 does not place the speakers at a fixed height and in precisely the specified location relative to the listener. The content consumer 14 may be unable to place speakers in these location or be unaware that there are even specified locations at which to place speakers to achieve a suitable surround sound experience. Using SHC enables a more flexible arrangement of speakers given that the SHC represent the sound field in two or three dimensions, meaning that from the SHC, an acceptable (or at least better sounding, in comparison to that of non-SHC audio systems) reproduction of sound field may be provided by speakers configured in most any speaker geometry.

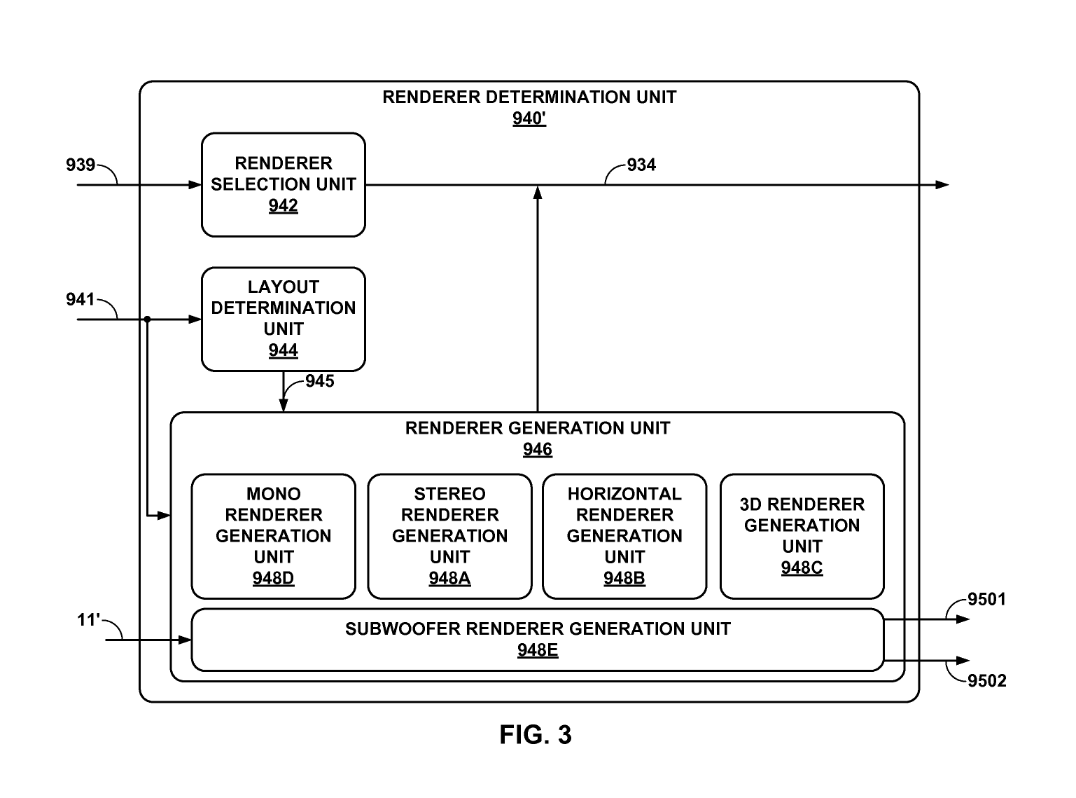

To facilitate rendering of the SHC to almost any local speaker geometry, the techniques described in this disclosure may enable the renderer determination unit 940 not only to select a standard renderer using the audio rendering information in the manner described above but to dynamically generate a renderer based on the local speaker geometry information included in loudspeaker information 13. As described in more detail with respect to FIGS. 3B-3J(ii), the techniques may provide for at least four exemplary ways by which to generate a renderer 22 tailored to a specific local speaker geometry specified by the local speaker geometry information included in loudspeaker information 13. These three ways may include a way by which to generate a mono renderer 22, a stereo renderer 22, a horizontal multi-channel renderer 22 (where, for example, “horizontal multi-channel” refers to a multi-channel speaker configuration having more than two speakers in which all of the speakers are generally on or near the same horizontal plane), and a three-dimensional (3D) renderer 22 (where a three-dimensional renderer may render for multiple horizontal planes of speakers).

In operation, the audio determination unit 940 may select a renderer out of audio renderers 22 based on the audio rendering information or the local speaker geometry information included in loudspeaker information 13. Often, the content consumer 14 may specify a preference that the renderer determination unit 940 select the renderer out of audio renderers 22 based on the audio rendering information (when present, as this may not be present in all bitstreams) and, when not present, determine (or select if previously determined) the renderer out of audio renderers 22 based on the local speaker geometry information included in loudspeaker information 13. In some instances, the content consumer 14 may specify a preference that the renderer determination unit 940 determine (or select if previously determined) the renderer out of audio renderers 22 based on the local speaker geometry information included in loudspeaker information 13 without ever considering the audio rendering information during the selection of the renderer out of audio renderers 22. While only two alternatives are provided, any number of preferences may be specified for configuring how the renderer determination unit 940 selects the renderer out of audio renderers 22 based on the audio rendering information included in the bitstream 21 and/or the local speaker geometry included in loudspeaker information 13. Accordingly, the techniques should not be limited in this respect to the two exemplary alternatives discussed above.

In any event, assuming that the renderer determination unit 940 is to determine the renderer out of audio renderers 22 based on the local speaker geometry information included in loudspeaker information 13, the renderer determination unit 940 may first categorize the local speaker geometry into one of the four categories briefly mentioned above. That is, the renderer determination unit 940 may first determine whether the local speaker geometry information included in loudspeaker information 13 indicates that the local speaker geometry generally conforms to a mono speaker geometry, a stereo speaker geometry, a horizontal multi-channel speaker geometry having three or more speakers on the same horizontal plane or a three-dimensional multi-channel speaker geometry having three or more speakers, two of which are on different horizontal planes (often separated by some threshold height). Upon categorizing the local speaker geometry based on this local speaker geometry information included in loudspeaker information 13, the renderer determination unit 940 may generate one of a mono renderer, a stereo renderer, a horizontal multi-channel renderer and a three-dimensional multi-channel renderer. The renderer determination unit 940 may then provide this renderer out of audio renderers 22 for use by the audio playback system 16, whereupon the audio playback system 16 may render the HOA coefficients 11′ in the manner described above to generate the multi-channel audio data 25.

The renderer determination unit 940 may also generate a low frequency (LF) audio renderer 9502 for use in rendering those of the higher-order ambisonic coefficients 11′ corresponding to a low frequency (which are denoted as low frequency higher-order ambisonic coefficients 9501 in the example of FIG. 2) to a loudspeaker feed 9503 for a low frequency speaker (e.g., a sub-woofer).

Typically, when rendering a loudspeaker feed for a low frequency speaker, those of the HOA coefficients 11′ corresponding to a zero-order spherical basis function are used. When there is not much bass content, rendering the low frequency speaker feed using those of the HOA coefficients 11′ corresponding to a zero-order spherical basis function typically results in a reproduced low frequency soundfield that is accurate and that blends well with the higher frequency soundfields being reproduced by higher frequency speakers (as perceived by a listener). However, when there is a larger degree of bass content, rendering the low frequency speaker feed using those of the HOA coefficients 11′ corresponding to a zero-order spherical basis function may result in a low frequency soundfield that does not blend well with the higher frequency soundfields being reproduced by higher frequency speakers (again, as perceived by a listener).

As a result, when the bass content is lower, the renderer determination unit 940 may determine a low frequency renderer that uses only those of the HOA coefficients 11′ corresponding to a zero-order spherical basis function. When the bass content of the soundfield is higher, the renderer determination unit 940 may then determine a different low frequency renderer that may utilize additional low frequency channels of the HOA coefficients 11′ (where these channels may refer to the HOA coefficients 11′ corresponding to a spherical basis function having an order, sub-order as follows: 0, 0|1, 0|1, −1|1, +1). The renderer determination unit 940 may identify the low frequency and non-low frequency (or, in other words, high frequency) HOA coefficients 11′ by applying a frequency crossover to the HOA coefficients 11′.

To identify when the bass content is to be classified as lower or higher, the renderer determination unit 940 may apply one or more classifiers to the HOA coefficients 11′. Examples of classifiers may comprise a subwoofer renderer classifier and a content classifier. The renderer determination unit 940 may apply the subwoofer renderer classifier to those of the HOA coefficients 11′ corresponding to the zeroth order spherical basis function of the full frequency HOA coefficients and the band limited low-frequency HOA coefficients. The subwoofer renderer classifier may effectively perform a form of cross correlation to identify whether the soundfield includes a high or low bass content. Cross correlation may refer to cross correlation as understood in the signal processing arts. In other words, cross correlation may refer to a measure of similarity between two waveforms (which in this case is defined as a discrete set of M samples) as a function of a time-lag applied to one of them. When cross correlation is high between the two sets of HOA coefficients 11′, the low-frequency HOA are likely to represent a soundfield having high bass content. When the cross correlation is low, the HOA coefficients 11′ are more likely to represent a sound field having low bass content (e.g. the signal is more likely to be noise).

The content classifier may make this determination in various ways. For example, the renderer determination unit 940 may use a 4^{th} order representation of the soundfield (e.g., meaning HOA coefficients 11′ have at least one coefficient corresponding to a fourth-order spherical basis function). In this example, the content classifier may code 24 channels and predict a 25^{th} channel. The content classifier may apply scalars to at least some of the 24 channels and add the resulting values to determine the 25^{th} channel. Furthermore, in this example, the content classifier may determine an accuracy of the predicted 25^{th} channel. In this example, when the accuracy of the predicted 25^{th} channel is relatively high (e.g., the accuracy exceeds a particular threshold), the HOA coefficients 27′ are likely to represent a soundfield having a lower bass content. In contrast, when the accuracy of the predicted 25^{th} channel is relatively low (e.g., the accuracy is below the particular threshold), the HOA coefficients 11′ are more likely to represent a sound field having a higher bass content.

The renderer determination unit 940 may apply one or both of the classifiers to the HOA coefficients 11′ in order to determine whether the bass content of the soundfield is high or low. When applying both of the classifiers (or multiple classifiers if more than two classifiers are utilized), the renderer determination unit 940 may perform any of a number of processes typically involved when multiple metrics are used to identify a single overall metric (e.g., normalization, averaging, weighted averaging, etc.).

Moreover, in some instances, the renderer determination unit 940 may determine that not all of the HOA coefficients 11′ corresponding to a low frequency are to be rendered by the low frequency renderer 9502. To illustrate, when there is a lot of bass content resembling noise, rendering those low frequency HOA coefficients 9501 may result in a reproduction of the soundfield by the low frequency speaker that is muddled or unclear (given that the low frequency speaker may not be able to respond sufficiently to accurately reproduce the soundfield). Moreover, in some instances, the location of the bass content may be above a certain elevation in the soundfield, such that a low frequency speaker (which is typically located at the bottom of the soundfield) may reproduce the soundfield inaccurately or in a manner that confuses listeners (especially when accompanied by visual content).

To overcome these issues, the renderer determination unit 940 may perform a form of vector-based analysis with respect to the low frequency HOA coefficients 9501 (which may refer to those of the HOA coefficients 11′ corresponding to a low frequency). By performing this vector-based analysis, the renderer determination unit 940 may determine distinct components of this low frequency soundfield represented by the low frequency HOA coefficients 9501 and spatial locations of the distinct components of the low frequency soundfield. For the non-distinct (or, in other words, non-prominent) components of the sound field, the renderer determination unit 940 may determine that the non-distinct components be rendered by the non-low frequency renderer. For the distinct low frequency components of the soundfield, the renderer determination unit 940 may determine whether the elevation of the distinct low frequency components is below some threshold (e.g., 15 degrees). When below the threshold, the renderer determination unit 940 may indicate that the distinct low frequency components are to be rendered by the low frequency renderer. When above the threshold, the renderer determination unit 940 may indicate that the distinct low frequency components are to be rendered by the non-low frequency renderer.

As noted above, the renderer determination unit 940 may perform a vector-based analysis, which may refer to a singular value decomposition, a principal component analysis, an eigenvalue decomposition or any similar vector-based analysis or linear transformation. While described with respect to SVD, the techniques may be performed with respect to any similar invertible linear transformation or decomposition that provides for sets of linearly uncorrelated data. Also, reference to “sets” in this disclosure is generally intended to refer to “non-zero” sets unless specifically stated to the contrary and is not intended to refer to the classical mathematical definition of sets that includes the so-called “empty set.”

An alternative transformation may comprise a principal component analysis, which is often abbreviated by the initialism PCA. PCA refers to a mathematical procedure that employs an orthogonal transformation to convert a set of observations of possibly correlated variables into a set of linearly uncorrelated variables referred to as principal components. Linearly uncorrelated variables represent variables that do not have a linear statistical relationship (or dependence) to one another. The principal components may be described as having a small degree of statistical correlation to one another. In any event, the number of so-called principal components is less than or equal to the number of original variables. Typically, the transformation is defined in such a way that the first principal component has the largest possible variance (or, in other words, accounts for as much of the variability in the data as possible), and each succeeding component in turn has the highest variance possible under the constraint that this successive component be orthogonal to (which may be restated as uncorrelated with) the preceding components. Depending on the context, PCA may be referred to by a number of different names, such as discrete Karhunen-Loeve transform, the Hotelling transform, proper orthogonal decomposition (POD), and eigenvalue decomposition (EVD) to name a few examples.

In any event, the renderer determination unit 940 may as one example perform a singular value decomposition (which, again, may be denoted by the initialism “SVD”) to transform the low frequency HOA coefficients 9501 into two or more sets of transformed HOA coefficients. The renderer determination unit 940 may perform the SVD with respect to the low frequency HOA coefficients 9501 to generate a so-called V matrix, a so-called S matrix and a so-called U matrix. SVD, in linear algebra, may represent a factorization of a m-by-n real or complex matrix X (where X may represent multi-channel audio data, such as the low frequency HOA coefficients 9501) in the following form:

X=USV* a.

U may represent an m-by-m real or complex unitary matrix, where the m columns of U are commonly known as the left-singular vectors of the multi-channel audio data. S may represent an m-by-n rectangular diagonal matrix with non-negative real numbers on the diagonal, where the diagonal values of S are commonly known as the singular values of the multi-channel audio data. V* (which may denote a conjugate transpose of V) may represent an n-by-n real or complex unitary matrix, where the n columns of V* are commonly known as the right-singular vectors of the multi-channel audio data.

While described in this disclosure as being applied to multi-channel audio data comprising the low frequency HOA coefficients 9501, the techniques may be applied to any form of multi-channel audio data. In this way, the renderer determination unit 940 may perform a singular value decomposition with respect to multi-channel audio data representative of at least a portion of sound field to generate a U matrix representative of left-singular vectors of the multi-channel audio data, an S matrix representative of singular values of the multi-channel audio data and a V matrix representative of right-singular vectors of the multi-channel audio data, and representing the multi-channel audio data as a function of at least a portion of one or more of the U matrix, the S matrix and the V matrix.

Generally, the V* matrix in the SVD mathematical expression referenced above is denoted as the conjugate transpose of the V matrix to reflect that SVD may be applied to matrices comprising complex numbers. When applied to matrices comprising only real-numbers, the complex conjugate of the V matrix (or, in other words, the V* matrix) may be considered equal to the V matrix. Below it is assumed, for ease of illustration purposes, that the low frequency HOA coefficients 9501 comprise real-numbers with the result that the V matrix is output through SVD rather than the V* matrix. While assumed to be the V matrix, the techniques may be applied in a similar fashion to HOA coefficients 11′ having complex coefficients, where the output of the SVD is the V* matrix. Accordingly, the techniques should not be limited in this respect to only providing for application of SVD to generate a V matrix, but may include application of SVD to the low frequency HOA coefficients 9501 having complex components to generate a V* matrix.

The renderer determination unit 940 may perform a block-wise form of SVD with respect to each block (which may refer to a frame) of higher-order ambisonics (HOA) audio data (where this ambisonics audio data includes blocks or samples of the low frequency HOA coefficients 9501 or any other form of multi-channel audio data). A variable M may be used to denote the length of an audio frame in samples. For example, when an audio frame includes 1024 audio samples, M equals 1024. The renderer determination unit 940 may therefore perform a block-wise SVD with respect to a block the low frequency HOA coefficients 9501 having M-by-(N_{LF})² HOA coefficients, where N_{LF} denotes the order of the low frequency HOA coefficients 9501 (and may, as one example, be equal to one). The renderer determination unit 940 may generate, through performing this SVD, the V matrix, the S matrix and the U matrix, where each of these matrixes may represent the respective V, S and U matrixes described in more detail above.

Based on one or more of the V, S and U matrices, the renderer determination unit 940 may identify distinct components of the soundfield represented by low frequency HOA coefficients 9501. Typically, the renderer determination unit 940 may identify the distinct components through analysis of the S matrices, selecting those distinct components for further analysis in terms of their elevation as described above. The renderer determination unit 940 may reconstruct the distinct components from the V, S and U matrices to generate distinct low frequency HOA coefficients, which may then be rendered using either the non-low frequency renderer or the low frequency renderer.

In this way, various aspects of the techniques enable the renderer determination unit 940 to determine a renderer to be used when rendering higher-order ambisonic coefficients into a speaker feed for a low frequency speaker based on application of a classifier to the higher-order ambisonic coefficients.

In these and other examples, the renderer determination unit 940 may be configured to apply the determined renderer to one or more channels of the higher-order ambisonic coefficients to generate the speaker feed for the low frequency speaker.

In these and other examples, the renderer determination unit 940 may be configured to determine the higher-order ambisonic coefficients that correspond to a low frequency, and determine the renderer to be used when rendering the higher-order ambisonic coefficients corresponding to the low frequency into the speaker feed for the low frequency speaker based on application of the classifier to the higher-order ambisonic coefficients corresponding to the low frequency.

In these and other examples, the renderer determination unit 940 may be configured to determine the higher-order ambisonic coefficients that correspond to a low frequency, determine the renderer to be used when rendering the higher-order ambisonic coefficients corresponding to the low frequency into the speaker feed for the low frequency speaker based on application of the classifier to the higher-order ambisonic coefficients corresponding to the low frequency, and apply the determined renderer to the higher-order ambisonic coefficients corresponding to the low frequency to generate the speaker feed for the low frequency speaker.

In these and other examples, the renderer determination unit 940 may be configured to apply a frequency crossover to the higher-order ambisonic coefficients to determine the higher-order ambisonic coefficients corresponding to the low frequency.

In these and other examples, the renderer determination unit 940 may be configured to perform a vector-based analysis with respect to the higher-order ambisonic coefficients or the higher-order ambisonic coefficients corresponding to the low frequency to identify whether each of the higher-order ambisonic coefficients corresponding to the low frequency are to be rendered to the speaker feed for the low frequency speaker or to a speaker feed for a non-low frequency speaker. In these and other examples, the vector-based analysis comprises a singular value decomposition.

In these and other examples, the classifier comprises a subwoofer renderer classifier that classifies using a form of cross correlation.

In these and other examples, the classifier comprises a content classifier.

In these and other examples, the determined renderer comprises a zero-order render, and the renderer determination unit 940 may be configured to apply the zero-order renderer to the higher-order ambisonic coefficients corresponding to a zero-order spherical basis function.

In these and other examples, wherein the determined renderer comprises a cardioid render, and the renderer determination unit 940 may be configured to apply the cardioid renderer to the higher-order ambisonic coefficients corresponding to a zero-order spherical basis function, a first order, zero sub-order spherical basis function, a first order, positive one sub-order spherical basis function, and a first order, negative one sub-order spherical basis function.

In these and other examples, the low frequency speaker comprises a sub-woofer.

Additionally, various aspects of the techniques may enable the renderer determination unit 940 to perform a vector-based analysis with respect to higher-order ambisonic coefficients corresponding to a low frequency to identify whether each of the higher-order ambisonic coefficients corresponding to the low frequency are to be rendered to the speaker feed for the low frequency speaker or to a speaker feed for a non-low frequency speaker.

In these and other examples, the renderer determination unit 940 may be configured to determine a renderer to be used when rendering the higher-order ambisonic coefficients corresponding to the low frequency into a speaker feed for the low frequency speaker based on application of a classifier to the higher-order ambisonic coefficients.

In these and other examples, the renderer determination unit 940 may be configured to apply the determined renderer to one or more channels of the higher-order ambisonic coefficients corresponding to the low frequency to generate the speaker feed for the low frequency speaker.

In these and other examples, the renderer determination unit 940 may be configured to determine the higher-order ambisonic coefficients that correspond to the low frequency, and determine the renderer to be used when rendering the higher-order ambisonic coefficients corresponding to the low frequency into the speaker feed for the low frequency speaker based on application of the classifier to the higher-order ambisonic coefficients corresponding to the low frequency.

In these and other examples, the renderer determination unit 940 may be configured to determine the higher-order ambisonic coefficients that correspond to the low frequency, determine the renderer to be used when rendering the higher-order ambisonic coefficients corresponding to the low frequency into the speaker feed for the low frequency speaker based on application of the classifier to the higher-order ambisonic coefficients corresponding to the low frequency, and apply the determined renderer to the higher-order ambisonic coefficients corresponding to the low frequency to generate the speaker feed for the low frequency speaker.

In these and other examples, the renderer determination unit 940 may be configured to apply a frequency crossover to the higher-order ambisonic coefficients to determine the higher-order ambisonic coefficients corresponding to the low frequency.

In these and other examples, the vector-based analysis comprises a singular value decomposition.

In these and other examples, the classifier comprises a subwoofer renderer classifier that classifies using a form of cross correlation.

In these and other examples, the classifier comprises a content classifier.

In these and other examples, the determined renderer comprises a zero-order render, and the renderer determination unit 40′ may be configured to apply the zero-order renderer to the higher-order ambisonic coefficients corresponding to a zero-order spherical basis function.

In these and other examples, the determined renderer comprises a cardioid render, and the renderer determination unit 40′ may be configured to apply the cardioid renderer to the higher-order ambisonic coefficients corresponding to a zero-order spherical basis function, a first order, zero sub-order spherical basis function, a first order, positive one sub-order spherical basis function, and a first order, negative one sub-order spherical basis function. In these and other examples, the low frequency speaker comprises a sub-woofer.

FIG. 3 is a block diagram illustrating the renderer determination unit 940 of FIG. 2 in more detail. As shown in the example of FIG. 3, the renderer determination unit 940 may include a renderer selection unit 942, a layout determination unit 944, and a renderer generation unit 946. The renderer selection unit 942 may represent a unit configured to select a pre-defined based on the rendering information 939 included in bitstream 21 or select the render specified in the rendering information 939, outputting this selected or specified renderer as the renderer 934 in audio renderer 22.

The layout determination unit 44 may represent a unit configured to categorize a local speaker geometry based on local speaker geometry information 941 included in loudspeaker information 13. The layout determination unit 944 may categorize the local speaker geometry to one of the three categories described above: 1) mono speaker geometry, 2) stereo speaker geometry, 3) a horizontal multi-channel speaker geometry, and 4) a three-dimensional multi-channel speaker geometry. The layout determination unit 944 may pass categorization information 945 to the renderer generation unit 946 that indicates to which of the three categories the local speaker geometry most conforms.

The renderer generation unit 946 may represent a unit configured to generate a renderer 934 based on the categorization information 945 and the local speaker geometry information 941. The renderer generation unit 946 may include a mono renderer generation unit 948D, a stereo renderer generation unit 948A, a horizontal renderer generation unit 948B, and a three-dimensional (3D) renderer generation unit 948C. The mono renderer generation unit 948A may represent a unit configured to generate a mono renderer based on the local speaker geometry information 941. The stereo renderer generation unit 948A may represent a unit configured to generate a stereo renderer based on the local speaker geometry information 941. The horizontal renderer generation unit 948B may represent a unit configured to generate a horizontal multi-channel renderer based on the local speaker geometry information 941. The 3D renderer generation unit 948C may represent a unit configured to generate a 3D multi-channel renderer based on the local speaker geometry information 941. More information regarding the renderer generation unit 946 and each of units 948A-948C is available in U.S. patent application Ser. No. 14/174,784, entitled “DETERMINING RENDERERS OF SPHERICAL HARMONIC COEFFICIENTS,” filed Feb. 6, 2014.

The renderer generation unit 946 of the renderer determination unit 940 further includes an addition unit, denoted as subwoofer renderer generation unit 948E. The subwoofer renderer generation unit 948E may receive the HOA coefficients 11′ in the manner described above and determine the low frequency renderer 9502 based an application of a classifier to the HOA coefficients 11′. The subwoofer renderer generation unit 948E may also output the low frequency HOA coefficients 9501 to which the low frequency renderer 9502 may be applied to generate the low frequency speaker feed for the low frequency speaker.

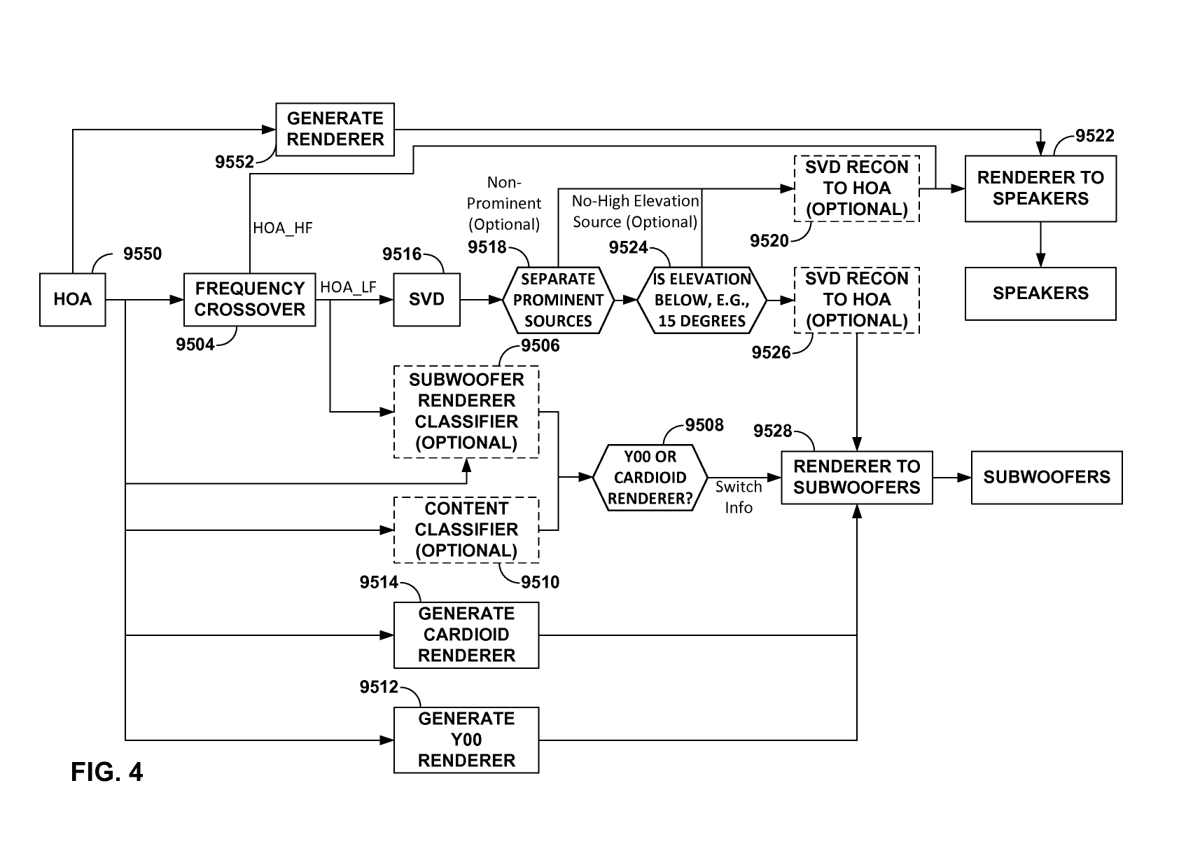

FIG. 4 is a flowchart illustrating exemplary operation of an audio playback system, such as audio playback system 16 shown in the example of FIG. 2, in performing the low frequency rendering techniques described in this disclosure. Initially, the renderer determination unit 940 of the audio playback system 16 may receive the HOA coefficients (9550) and generate a non-low frequency renderer 22 consistent with various aspects of the techniques described above (9552).

The renderer determination unit 940 may invoke the subwoofer renderer generation unit 948E to determine the low frequency renderer 9502. The subwoofer renderer generation unit 948 may perform a frequency crossover with respect to the HOA coefficients 11′ to identify high frequency HOA coefficients (HOA_HF) and low frequency HOA coefficients 9501 (HOA_LF) (9554). The subwoofer renderer generation unit 948E may then apply one or more classifiers to the low frequency HOA coefficients 9501 and/or the HOA coefficients 11′.

The subwoofer renderer generation unit 948E may, as one example, apply a subwoofer renderer classifier to the low frequency HOA coefficients 9501 (9506). The subwoofer renderer generation unit 948E may then determine whether to use a zero-order renderer or a cardioid renderer to render the low frequency HOA coefficients 9501 based on the application of the subwoofer renderer classifier (9508). Alternatively or in conjunction to the application of the subwoofer renderer classifier, the subwoofer renderer generation unit 948E may apply a content classifier to the HOA coefficients 11′ (9510) and, based on application of this content classifier, determine whether to use the zero-order renderer or the cardioid renderer to render the low frequency HOA coefficients 9501 (9508). When the zero-order renderer is selected, the subwoofer renderer generation unit 948E generates the zero-order renderer (9512). When the cardioid renderer is selected, the subwoofer renderer generation unit 948E generates the first order or cardioid renderer (9514).

The subwoofer renderer generation unit 948E may also perform an SVD with respect to the low frequency HOA coefficients 9501 to identify distinct or prominent components of the low frequency soundfield in the manner described above (9516). For those components of the low frequency soundfield that are ambient or non-prominent (9518), the subwoofer renderer generation unit 948E may indicate that these components (which may be reconstructed to form HOA coefficients (9520)) are to be rendered by the non-low frequency renderer 22 (9522). For those components of the low frequency soundfield that are prominent or distinct, the subwoofer renderer generation unit 948E may determine whether these distinct components are at a location within the soundfield below some threshold height (e.g., 15 degrees) (9524). For those prominent components that are above the threshold elevation or height, the subwoofer renderer generation unit 948E may indicate that these components (which may be reconstructed to form HOA coefficients (9520)) are to be rendered by the non-low frequency renderer 22 (9522). For those prominent components that are below the threshold elevation, the subwoofer renderer generation unit 948E may indicate that these components are to be rendered by the determined low frequency renderer (e.g., the zero-order renderer or the cardioid or first order renderer) possibly after reconstructing these components to form HOA coefficients (9526, 9528).

The foregoing techniques may be performed with respect to any number of different contexts and audio ecosystems. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., Eigen microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into the HOA coefficients for playback by one or more of the playback elements. For instance, a user of the mobile device may record (acquire a soundfield of) a live event (e.g., a meeting, a conference, a play, a concert, etc.), and code the recording into HOA coefficients.

The mobile device may also utilize one or more of the playback elements to playback the HOA coded soundfield. For instance, the mobile device may decode the HOA coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a set of headphones, e.g., to create realistic binaural sound.

In some examples, a particular mobile device may both acquire a 3D soundfield and playback the same 3D soundfield at a later time. In some examples, the mobile device may acquire a 3D soundfield, encode the 3D soundfield into HOA, and transmit the encoded 3D soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of HOA signals. For instance, the one or more DAWs may include HOA plugins and/or tools which may be configured to operate with (e.g., work with) one or more game audio systems. In some examples, the game studios may output new stem formats that support HOA. In any case, the game studios may output coded audio content to the rendering engines which may render a soundfield for playback by the delivery systems.

The techniques may also be performed with respect to exemplary audio acquisition devices. For example, the techniques may be performed with respect to an Eigen microphone which may include a plurality of microphones that are collectively configured to record a 3D soundfield. In some examples, the plurality of microphones of Eigen microphone may be located on the surface of a substantially spherical ball with a radius of approximately 4 cm. In some examples, the audio encoding device 20 may be integrated into the Eigen microphone so as to output a bitstream 21 directly from the microphone.

Another exemplary audio acquisition context may include a production truck which may be configured to receive a signal from one or more microphones, such as one or more Eigen microphones. The production truck may also include an audio encoder, such as audio encoder 20 of FIG. 2.

The mobile device may also, in some instances, include a plurality of microphones that are collectively configured to record a 3D soundfield. In other words, the plurality of microphone may have X, Y, Z diversity. In some examples, the mobile device may include a microphone which may be rotated to provide X, Y, Z diversity with respect to one or more other microphones of the mobile device. The mobile device may also include an audio encoder, such as audio encoder 20 of FIG. 2.

A ruggedized video capture device may further be configured to record a 3D soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a 3D soundfield that represents the action all around the user (e.g., water crashing behind the user, another rafter speaking in front of the user, etc. . . . ).

The techniques may also be performed with respect to an accessory enhanced mobile device, which may be configured to record a 3D soundfield. In some examples, the mobile device may be similar to the mobile devices discussed above, with the addition of one or more accessories. For instance, an Eigen microphone may be attached to the above noted mobile device to form an accessory enhanced mobile device. In this way, the accessory enhanced mobile device may capture a higher quality version of the 3D soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a 3D soundfield. Moreover, in some examples, headphone playback devices may be coupled to a decoder 24 via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the 3D soundfield of the sports game may be acquired (e.g., one or more Eigen microphones may be placed in and/or around the baseball stadium), HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the audio encoding device 20 may perform a method or otherwise comprise means to perform each step of the method for which the audio encoding device 20 is configured to perform In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio encoding device 20 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the audio decoding device 24 may perform a method or otherwise comprise means to perform each step of the method for which the audio decoding device 24 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio decoding device 24 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the techniques have been described. These and other aspects of the techniques are within the scope of the following claims.

1. A device configured to render higher-order ambisonic coefficients, the device comprising:
a memory configured to store the higher-order ambisonic coefficients; and
one or more processors configured to obtain a renderer to be used when rendering the higher-order ambisonic coefficients into a speaker feed for a low frequency speaker.

2. The device of claim 1, wherein the one or more processors are further configured to apply the obtained renderer to one or more channels of the higher-order ambisonic coefficients to generate the speaker feed for the low frequency speaker.

3. The device of claim 1, wherein the one or more processors are further configured to obtain the higher-order ambisonic coefficients that correspond to a low frequency,
wherein the one or more processors are configured to obtain the renderer to be used when rendering the higher-order ambisonic coefficients corresponding to the low frequency into the speaker feed for the low frequency speaker.

4. The device of claim 3, wherein the one or more processors are configured to apply a frequency crossover to the higher-order ambisonic coefficients to determine the higher-order ambisonic coefficients corresponding to the low frequency.

5. The device of claim 3, wherein the one or more processors are further configured to perform a vector-based analysis with respect to the higher-order ambisonic coefficients or the higher-order ambisonic coefficients corresponding to the low frequency to identify whether each of the higher-order ambisonic coefficients corresponding to the low frequency are to be rendered to the speaker feed for the low frequency speaker or to a speaker feed for a non-low frequency speaker.

6. The device of claim 5, wherein the vector-based analysis comprises a singular value decomposition.

7. The device of claim 1, wherein the one or more processors are further configured to obtain the higher-order ambisonic coefficients that correspond to a low frequency,
wherein the one or more processors are configured to obtain the renderer to be used when rendering the higher-order ambisonic coefficients corresponding to the low frequency into the speaker feed for the low frequency speaker, and
wherein the one or more processors are configured to apply the obtained renderer to the higher-order ambisonic coefficients corresponding to the low frequency to generate the speaker feed for the low frequency speaker.

8. The device of claim 1, wherein the one or more processors are configured to obtain the renderer to be used when rendering higher-order ambisonic coefficients into the speaker feed for the low frequency speaker based on application of a classifier to the higher-order ambisonic coefficients.

9. The device of claim 8, wherein the classifier comprises a subwoofer renderer classifier that classifies the higher-order ambisonic coefficients using a form of cross correlation.

10. The device of claim 8, wherein the classifier comprises a content classifier.

11. The device of claim 1,
wherein the obtained renderer comprises a zero-order render, and
wherein the one or more processors are configured to apply the zero-order renderer to the higher-order ambisonic coefficients corresponding to a zero-order spherical basis function.

12. The device of claim 1,
wherein the obtained renderer comprises a cardioid render, and
wherein the one or more processors are further configured to apply the cardioid renderer to the higher-order ambisonic coefficients corresponding to a zero-order spherical basis function, a first order, zero sub-order spherical basis function, a first order, positive one sub-order spherical basis function, and a first order, negative one sub-order spherical basis function.

13. The device of claim 1, wherein the low frequency speaker comprises a subwoofer.

14. A method of rendering higher-order ambisonic coefficients, the method comprising:
obtaining a renderer to be used when rendering the higher-order ambisonic coefficients into a speaker feed for a low frequency speaker.

15. The method of claim 14, further comprising applying the obtained renderer to one or more channels of the higher-order ambisonic coefficients to generate the speaker feed for the low frequency speaker.

16. The method of claim 14, further comprising obtaining the higher-order ambisonic coefficients that correspond to a low frequency,
wherein obtaining the renderer comprises obtaining the renderer to be used when rendering the higher-order ambisonic coefficients corresponding to the low frequency into the speaker feed for the low frequency speaker.

17. The method of claim 16, wherein obtaining the higher-order ambisonic coefficients corresponding to the low frequency comprises applying a frequency crossover to the higher-order ambisonic coefficients to determine the higher-order ambisonic coefficients corresponding to the low frequency.

18. The method of claim 16, wherein obtaining the higher-order ambisonic coefficients corresponding to the low frequency comprises performing a vector-based analysis with respect to the higher-order ambisonic coefficients or the higher-order ambisonic coefficients corresponding to the low frequency to identify whether each of the higher-order ambisonic coefficients corresponding to the low frequency are to be rendered to the speaker feed for the low frequency speaker or to a speaker feed for a non-low frequency speaker.

19. The method of claim 18, wherein the vector-based analysis comprises a singular value decomposition.

20. The method of claim 14, further comprising obtaining the higher-order ambisonic coefficients that correspond to a low frequency,
wherein obtaining the renderer comprises obtaining the renderer to be used when rendering the higher-order ambisonic coefficients corresponding to the low frequency into the speaker feed for the low frequency speaker, and
wherein the method further comprises applying the obtained renderer to the higher-order ambisonic coefficients corresponding to the low frequency to generate the speaker feed for the low frequency speaker.

21. The method of claim 14, wherein obtaining the renderer comprises obtaining the renderer to be used when rendering higher-order ambisonic coefficients into the speaker feed for the low frequency speaker based on application of a classifier to the higher-order ambisonic coefficients.

22. The method of claim 21, wherein the classifier comprises a subwoofer renderer classifier that classifies the higher-order ambisonic coefficients using a form of cross correlation.

23. The method of claim 21, wherein the classifier comprises a content classifier.

24. The method of claim 14,
wherein the obtained renderer comprises a zero-order render, and
wherein the method further comprises applying the zero-order renderer to the higher-order ambisonic coefficients corresponding to a zero-order spherical basis function.

25. The method of claim 14,
wherein the obtained renderer comprises a cardioid render, and
wherein the method further comprises applying the cardioid renderer to the higher-order ambisonic coefficients corresponding to a zero-order spherical basis function, a first order, zero sub-order spherical basis function, a first order, positive one sub-order spherical basis function, and a first order, negative one sub-order spherical basis function.

26. The method of claim 14, wherein the low frequency speaker comprises a subwoofer.

27. A device configured to render higher-order ambisonic coefficients, the device comprises
means for storing the higher-order ambisonic coefficients; and
means for obtaining a renderer to be used when rendering the higher-order ambisonic coefficients into a speaker feed for a low frequency speaker.

28. The device of claim 27, further comprising means for obtaining the higher-order ambisonic coefficients that correspond to a low frequency by one or more of applying a frequency crossover to the higher-order ambisonic coefficients and performing a vector-based analysis with respect to the higher-order ambisonic coefficients,
wherein the means for obtaining the renderer comprises means for obtaining the renderer to be used when rendering the higher-order ambisonic coefficients corresponding to the low frequency into the speaker feed for the low frequency speaker.

29. The device of claim 27, wherein the means for obtaining the renderer comprises means for obtaining the renderer to be used when rendering higher-order ambisonic coefficients into the speaker feed for the low frequency speaker based on application of a classifier to the higher-order ambisonic coefficients, wherein the classifier comprises one of a subwoofer renderer classifier that classifies the higher-order ambisonic coefficients using a form of cross correlation and a content classifier.

30. A non-transitory computer-readable storage medium having stored thereon instructions that, when executed, cause one or more processors to:
store higher-order ambisonic coefficients; and
obtain a renderer to be used when rendering the higher-order ambisonic coefficients into a speaker feed for a low frequency speaker.
